(19) United States
(12) Patent Application Publication
(10) Pub. No.: US 2009/0302551 A1
(43) Pub. Date: Dec. 10, 2009

(54) FLAT SEAL WITH ADHESIVELY BONDED OR INSERTED FUNCTIONAL ELEMENT FOR INTERNAL COMBUSTION ENGINE

(76) Inventor: Ralf Salameh, Gondelsheim (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/279,604

(22) PCT Filed: Jan. 18, 2007
(86) PCT No.: PCT/EP2007/000437

§ 371 Date: Jun. 25, 2009

(30) Foreign Application Priority Data
Feb. 16, 2006 (DE) 10 2006 007 313.4

(51) Int. Cl. F02F 11/00

(52) U.S. Cl. 277/592

(57) ABSTRACT

A flat seal of a metal support with elastomer coating has areas which are usually stressed particularly intensively by local excess pressures and relative movements. Function elements are provided in these areas which relieve the stress of the seal. The function elements can be foils of metal or plastic which are glued on one side or on both sides. Alternatively, a flat metal or plastic element can be inserted into a free-stamped recess of the metal support of the seal and clamped in or glued on there. In both cases, by hardness, structuring and/or thickness of the function element, it is brought about that the forces occurring on the seal do not exceed the permissible material limits. Thereby, an excessive wear of the flat seal is prevented in applications having a high stress.

### TECHNICAL FIELD

The present invention relates to a flat seal for high stress, which comprises a preferably elastomer-coated metal support, in particular for internal combustion engines. According to the type of construction, flat seals are exposed to high stresses by pressing forces and relative movements, which can lead to an intensive wear of the flat seal and finally to a failure of the seal. By glueing on or inserting a load-relieving function element in particularly critical areas of the seal, these wear phenomena are to be reduced.

### PRIOR ART

There are several different basic types of flat seals. These include, for example, the seals which are generally designated as paper seals, or seals with a metallic sheet metal core and an elastomer coating, which are normally corrugated to increase pressure. A further possible embodiment is, for example, the flat seal described in the patent EP 1023549 B1, in which a sheet metal core is provided with an elastomer coating and sealing lips.

These seals are used in areas in which no very great component tolerances have to be balanced out. The sealing function of a flat seal is achieved by pressing the seal between flanges or components. All these seals have in common the fact that they lie in the flux of force of the housings or flange screw connections and therefore are greatly stressed by the screwing forces. These stresses naturally occur in particular in the fastening areas or screwing areas of a flat seal, but also other circumstances such as a small flange area or contact area with the flanges can lead locally to an intensive excess of the local area pressure at this location. Additional factors, such as torsions which occur, which can lead to a relative movement between the housing parts (micro movements), or vibration stresses by moving parts in a gear, additionally load the seal composite and can lead to an over-stressing of the sealing system.

As flat seals, due to their type of construction, lie in the flux of force of the screw connection between the flanges, the possibility of a reduction to the screwing forces is very limited, because otherwise problems occur with a reduction to the breakaway moment of the screw and these can be loosened. In addition, a reduction to the screwing forces and hence of the contact pressure would again lead to the deformations and/or relative movements between the flanges being intensified, and thus the stress occurring thereby and the wear of the seal is further increased. In addition, the operating conditions, such as temperatures and media contact likewise have an influence on the material. The wear caused by the intensive pressure and the torsions/relative movements can finally lead to a complete failure of the sealing function.

This means that these seals at locally very high pressures, intensive deformations of housing components and/or relative movements specifically with more highly stressed housings with high screwing forces and small flange- or contact areas are over-stressed and can not be used. In these cases, until now a different, generally more expensive type of seal construction therefore has to be chosen. This may, for example, be a seal with a metallic supporting frame, on which the sealing lips are vulcanized on the end side. In this type of construction, however, in contrast to a flat seal, the essential functions of the transmission of the screwing forces and the sealing function are separate from each other.

It is therefore the object of the invention to provide a solution for flat seals for internal combustion engines, in which the areas which are greatly stressed and worn by various influences due to the type of construction are “relieved of load”, so that the permissible material stress limits are not exceeded.

The problem of solved according to a first aspect of the invention by a flat seal according to Claim 1, which comprises a metal support which has a coating of an elastomer material, in which in at least one pre-determined area of the flat seal respectively a function element is glued on, which comprises a flat material piece. The glued-on function element receives a portion of the pressure forces and therefore makes provision that the seal is not excessively stressed despite permanently high screwing forces. A liquid elastomer coating, which is known as LEM (liquid elastomer moulding) is preferred here for the coating.

Preferably, the glued-on function element is a foil. A thin layer of suitable material can be sufficient to achieve a relieving of load of the seal, without substantially altering the thickness of the flat seal in this area.

In a preferred embodiment, function elements are glued on symmetrically on both sides of the metallic support. Thereby, the pressure forces are distributed more uniformly onto the seal.

Preferably, the at least one region in which the function element is glued on is not coated with the elastomer material. A glueing directly with the metal support can be able to be stressed more according to the construction than with an elastomer layer lying therebetween.

According to a second aspect of the invention, the problem is solved by a flat seal which comprises a metal support which has a coating of an elastomer material, in which in at least one pre-determined area of the flat seal respectively a recess is formed, in which a function element is inserted. The pressure forces therefore act principally on the function element, because the forces can only be transferred laterally onto the metal support of the flat seal.

In a preferred embodiment, the function element is glued in in the recess. This provides for a secure connection with the metal support of the seal. In a further preferred embodiment, the function element is clamped in the recess. This has the advantage that no additional adhesives are necessary.

It is preferred that the at least one function element is formed from a metallic material. A metallic layer is very resistant and can be adapted specifically to the intensive forces which occur.

Alternatively, it is preferred that the at least one function element is formed from plastic. Such elements could be produced at a very favourable cost; in addition, plastics exist for very many different requirements as regards the material characteristics.

It is, in addition, preferred that the metal support has at least one opening to receive a fastening element, in which the function element extends around the fastening opening in a sector of 60°-120°, preferably 70°-110°, particularly preferably 90°, which is adjacent to the fastening opening. Thereby, the function element sufficiently covers the areas of critical stress in the vicinity of the screwing openings, without influencing the sealing areas on the opposite side.

The outer surfaces of the function element preferably have a surface structure. These structure has the advantage of increasing the friction of the seal with the flanges and therefore of reducing relative movements which occur.

### BRIEF DESCRIPTION OF THE DRAWINGS

The invention is now described in more detail in connection with a description of example embodiments and with the aid of the enclosed drawings, in which:

FIG. 1a shows a perspective view of a flat seal according to the prior art;

FIG. 1b shows a cross-section through the sealing area of a flat seal according to the prior art;

FIG. 2 shows an embodiment according to the invention of a flat seal which is provided with a function element in the screwing area;

FIG. 3a shows a cross-section through a flat seal according to the prior art;

FIG. 3b shows in cross-section an embodiment of a flat seal according to the invention with function elements glued on both sides; and

FIG. 3c shows in cross-section an embodiment according to the invention with an inserted function element.

### DETAILED DESCRIPTION OF THE INVENTION

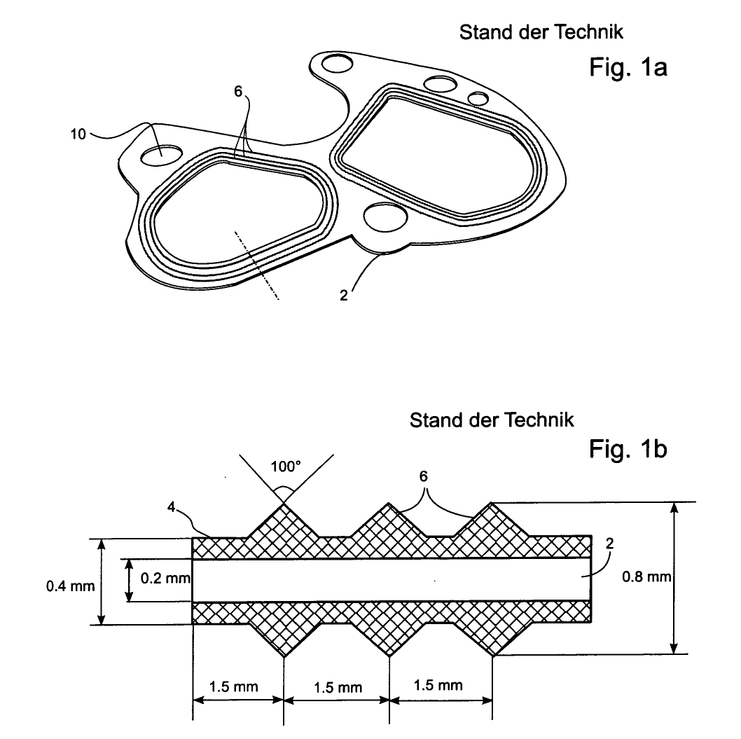

FIG. 1 shows an example flat seal 1 according to the prior art. In FIG. 1a a perspective view can be seen, whilst in FIG. 1b a cross-section is illustrated. The seal has a metallic base support 2 and is coated with an elastomer material 4. In addition, several, in this case three, sealing lips 6, running parallel, are formed from the elastomer material. These have a triangular cross-section and run, as shown in FIG. 1a, respectively around the entire sealing opening. The seal has fastening openings 10 for screwing with other components. Further details of the seal such as additional sealing elements, corrugations etc. are not shown here, but are known to the specialist in the art. As shown in FIG. 1b, example measurements for the various elements of the seal are as follows: the metallic core 2 has a thickness of 0.2 mm, the overall thickness x of the seal is 0.4 mm, so that in this example on each side an elastomer coating 4 of 0.1 mm thickness is applied. The thickness of the flat seal, measured up to the tips of the sealing lips 6, is 0.8 mm. The enclosed angle of the triangular lips 6, which respectively lie 1.5 mm away from each other (from tip to tip) is to be approximately 100°. Depending on the application, the dimensions of the flat seal can, however, of course also deviate from these values.

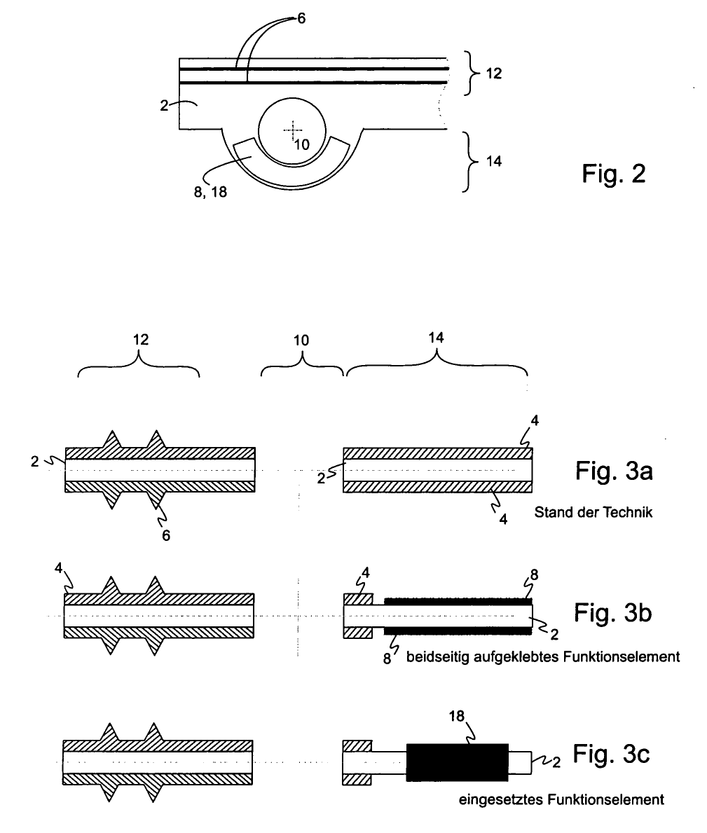

FIG. 2 shows a cut-out of a flat seal 1 according to the invention. Here, a fastening opening 10 can be seen, which serves for screwing the seal. Above the fastening opening 10, two sealing lips 6 are illustrated, running parallel. The area 14 around the fastening opening 10, as has already been discussed, is subject to particularly high stresses by intensive pressures. In order to relieve this area, a function element 8, 18 was therefore arranged. The function element can extend over a desired area 14, outside the sealing area 12. The shape and size shown in the drawing is only to be regarded as an example here. Thus, the function element could be adapted both to the shape and size of the highly stressed area and also for example to the shape and size of the screws which are used for the pressing. The elements could be standardized for particular screw sizes and automatically glued on.

A seal composite is therefore produced here, which consists of the actual sheet metal support and the unction element arranged thereon. In this way, one obtains two different function areas, on the one hand the elastomer-coated sealing area, which also has the sealing lips, and on the other hand an area which is for example completely metallic (or provided with other suitable materials). The aim is to receive a portion of the forces brought about by the pressing and screwing of the seal by the function element, in order to not press the seal in the elastomer area beyond the permissible material limits. Basically, however, through this function separation which is thus achieved, the nature of the seal does not alter, which is further screwed between the flange areas and lies in the flux of force.

FIG. 3a shows a cut-out of a flat seal according to the prior art in cross-section. As also in FIG. 2, a sealing area can be seen with two sealing lips 6, a fastening opening 10 and an area 14 around the fastening opening. The metal support 4 is coated in all areas with an elastomer. Compared with this, in FIGS. 3b and 3c example embodiments of the invention are shown, in which function elements 8, 18 relieving stress in different ways are arranged in the highly stressed area 14.

The arrangement of these function elements 8, 18 can take place for example by glueing on with a suitable adhesive. Here, a flat material piece can be glued cn symmetrically from both sides, as is shown in FIG. 3b. In a particular embodiment, this can also take place non-symmetrically on one side or both sides. The glued-on function element 8 can be produced in a suitable thickness for the respective application and can consist, for example, of a foil of metal or plastic. Here, as illustrated in FIG. 3b, the area of the metal support 2 in which the function element 8 is glued on can be uncoated, in contrast to the seal which is otherwise coated with elastomer on both sides; this could be more favourable with regard to the adhesive characteristics.

In a further preferred embodiment, the function element 18 can be glued in or mechanically fixed into a free stamping.

A mechanical fixing is achieved for example by clamping into a free-stamped recess of the metal support 2, which is minimally smaller than the function element 18. Such a function element, inserted into a recess, is shown in FIG. 3c.

Alternatively, for example a stamping/impressing of the metal support 2 on one side or on both sides, but not continuous, could be carried out, into which a function element 8, 18 is inserted and is in turn fixed in a suitable manner by glueing or clamping (not shown).

In both variants (glued on/inserted), the possibility exists of modifying the surfaces of the function elements 8, 18. By roughening or structuring the surfaces lying on the exterior, in addition an increase in the friction can be brought about to receive the high surface pressures, whereby relative movements between the seal 1 and the flanges are reduced or prevented. Such a structuring can be achieved for example by impressions of the function element 8, 18.

In order to achieve an efficient relieving of stress of the flat seal, the material of the function element 8, 18 can be selected so that it has a greater hardness and/or higher wear resistance than the support material 2 of the remaining seal. In addition to metals and plastics, as mentioned, other materials also come into consideration for the inserted or glued-on function element, as the specialist in the art will recognize.

The thickness of the function elements is selected so that the pressing of the seal, which is necessary for sealing the components, can be achieved. On reaching this thickness, the function elements take over a majority of the screwing forces and thereby relieve the stress of the sealing area 12. The thickness of the foil 8 or of the insert element 18 can be freely selected here and can be exchanged in a simple manner. This offers the possibility, for example, of adapting a seal to different conditions, or in the case of a testing of the seal, of testing different types, shapes and materials of function elements, in order to finally find a suitable element for manufacture in large quantities.

The shape and geometry of the glued-on or inserted function element can equally be selected to be flexible. For example, the element can be designed so that it is adapted exactly to the geometry of the seal and of other components. Here, such a function element can be used at any desired locations. It could be arranged in all free areas of a seal or only in the areas 14 of the screw connection. For example, it is also conceivable that such an element is only arranged at a particular location where, on the basis of previous tests or calculations, it is known that particularly high stresses occur there. As described and as shown in the examples and drawings, these can be the screwing areas or else areas in which for example, owing to component deformations or constricted space conditions, a locally increased pressure onto the seal is present.

A development tool is thereby produced which is able to be used flexibly, in order to decrease local stress peaks which lead to an overloading and damage to the seal. The additionally arranged function element brings about a local separation of functions, because the pressure forces are now received in an intensified manner by the function element. In this way, a seal is obtained which can be produced in a simple manner by conventional methods and which, owing to the increased wear capability can now be used in broader fields of application than flat seals known hitherto.

1. A flat seal for high stress, comprising a metal support which has a coating of an elastomer material, wherein in at least one predetermined area of the flat seal a function element is glued on, which comprises a flat material piece.

2. The flat seal according to claim 1, in which the at least one function element is formed from a metallic material.

3. The flat seal according to claim 1, in which the at least one function element is formed from plastic.

4. The flat seal according to claim 1, in which the function element is a foil.

5. The flat seal according to claim 1, in which function elements are arranged symmetrically on both sides of the metallic support.

6. The flat seal according to claim 1, in which the at least one area, in which the function element is glued on, is not coated with the elastomer material.

7. The flat seal according to claim 1, any of the preceding claims, in which the metal support has an opening to receive a fastening element, in which the function element extends around the fastening opening in a sector of 60°-120°, preferably 70°-110°, particularly preferably 90°, which is adjacent to the fastening opening.

8. The flat seal according to claim 1, in which the outer surfaces of the function element have a surface structure.

9. A flat seal for high stress, comprising a metal support which has a coating of an elastomer material, wherein in at least one pre-determined area of the flat seal a recess is formed, in which a function element is inserted.

10. The flat seal according to claim 9, in which the function element is glued in the recess.

11. The flat seal according to claim 9, in which the function element is clamped in the recess.

12. The flat seal according to claim 9, in which the function element is made from a mctal.

13. The flat seal according to claim 9, in which the function element is made from a plastic.

14. The flat seal according to claim 9, in which the metal support has an opening to receive a fastening element, in which the function element extends around the fastening opening in a sector of 60°-120°, preferably 70°-110°, particularly preferably 90°, which is adjacent to the fastening opening.

15. The flat seal according to claim 9, in which the function element is a pressure element.

16. The flat seal according to claim 9, in which the outer surfaces of the function element have a surface structure.
